(19) United States
(12) Patent Application Publication
(10) Pub. No.: US 2011/0219940 A1
(43) Pub. Date: Sep. 15, 2011

(54) SYSTEM AND METHOD FOR GENERATING CUSTOM SONGS

(76) Inventor: Hubin JIANG, Great Falls, VA (US)

(21) Appl. No.: 12/721,943

(22) Filed: Mar. 11, 2010

(51) Int. Cl. G10H 1/06

(52) U.S. Cl. 84/622

(57) ABSTRACT

An expert system based system for customizing a song for a system user. The system includes a song acquisition module having access to the internet, a knowledge acquisition control consol, the knowledge acquisition control consol operatively connected to the song acquisition module, a characteristics extraction module the characteristics extraction module operatively connected to the song acquisition module, knowledge generation module, the knowledge generation module configured to communicate with the knowledge acquisition control consol, a knowledge base module, the knowledge base module configured to work with the inference engine module and communicate with the knowledge acquisition control consol the inference engine module configured to use the knowledge base for reasoning and communicate with the song synthesizer; and an a graphics user interface to interface with system users and a song synthesizer for generating a song according to the requirements of a system user.

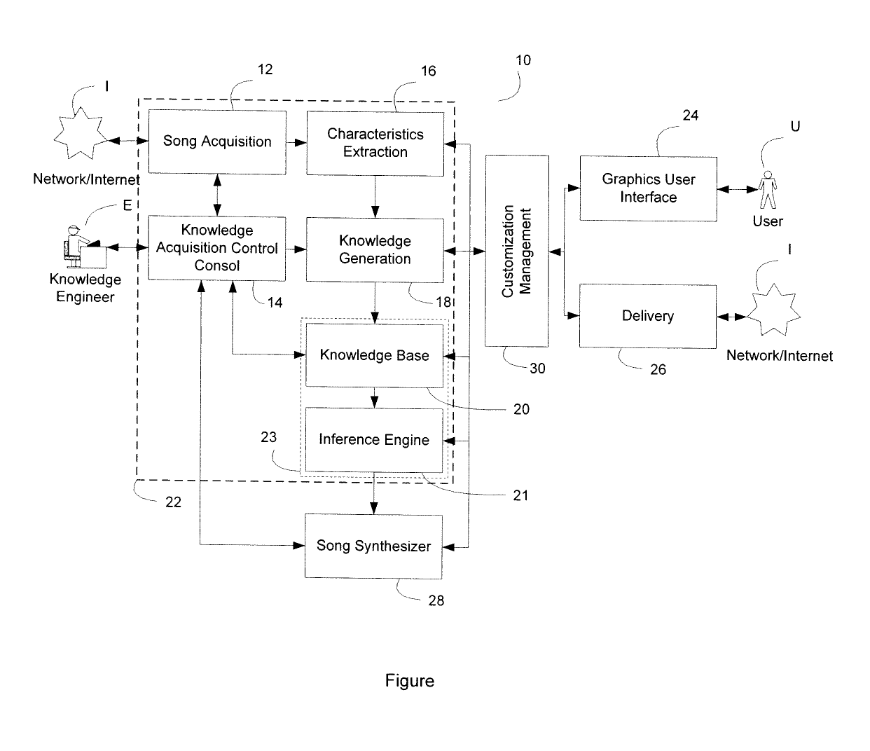

### FIELD

This document relates to computer implemented systems and methods for generating and distributing customized songs and other media.

### BACKGROUND

Efforts have been made in the past to customize songs. Recent efforts have enabled a user to manipulate music tracks to customize a favorite song to specific preferences. Musicians can record tracks individually and collaborate via the Internet to produce a song, while never having met face to face. Extant song customization software programs permit users to combine multiple previously recorded music tracks to create a custom song. The user may employ pre-recorded tracks in a variety of formats, or alternatively, may record original tracks for combination with pre-recorded tracks to achieve the customized end result.

Certain software applications employ Karaoke-type recordation of song lyrics for subsequent insertion or combination with previously recorded tracks in order to customize a song. As may be appreciated, in these applications, a user must sing into a microphone while the song he or she wishes to customize is playing so that both the original song and the user's voice can be recorded simultaneously. Other applications provide mixing programs to permit a user to combine previously recorded tracks in an attempt to create a unique song. However, such recording systems are often complex, expensive and time consuming, requiring a relatively high level of skill for a user that desires rapid access to a personalized, custom recording.

U.S. Pat. No. 6,288,319 proposes a method for creating an electronic greeting card with a custom audio mix over a computer network. The method proposed includes the steps of selecting a pre-recorded song from a song database; downloading the pre-recorded song from the song database, via a server computer, to a client computer over the computer network; recording a vocal track on the client computer while simultaneously playing back the pre-recorded song on the client computer; mixing the vocal track with the pre-recorded song, thereby creating a custom audio mix; saving the custom audio mix on the server computer; assembling the audio mix into an electronic greeting card format; and delivering the electronic greeting card to a recipient via the computer network.

U.S. Pat. No. 6,992,245 proposes that a frequency spectrum may be detected by analyzing a frequency of a voice waveform corresponding to a voice synthesis unit formed of a phoneme or a phonemic chain. Local peaks are detected on the frequency spectrum, and spectrum distribution regions including the local peaks are designated. For each spectrum distribution region, amplitude spectrum data representing an amplitude spectrum distribution depending on a frequency axis and phase spectrum data representing a phase spectrum distribution depending on the frequency axis are generated. The amplitude spectrum data is adjusted to move the amplitude spectrum distribution represented by the amplitude spectrum data along the frequency axis based on an input note pitch, and the phase spectrum data is adjusted corresponding to the adjustment. Spectrum intensities are adjusted to be along with a spectrum envelope corresponding to a desired tone color. The adjusted amplitude and phase spectrum data are converted into a synthesized voice signal.

U.S. Pat. No. 7,124,084 proposes a singing voice-synthesizing method and apparatus capable of performing synthesis of natural singing voices close to human singing voices based on performance data being input in real time. Performance data is inputted for each phonetic unit constituting a lyric, to supply phonetic unit information, singing-starting time point information, singing length information, etc. Each performance data is inputted in timing earlier than the actual singing-starting time point, and a phonetic unit transition time length is generated. By using the phonetic unit transition time, the singing-starting time point information, and the singing length information, the singing-starting time points and singing duration times of the first and second phonemes are determined. In the singing voice synthesis, for each phoneme, a singing voice is generated at the determined singing-starting time point and continues to be generated for the determined singing duration time.

U.S. Pat. No. 7,135,636 proposes a method for synthesizing a natural-sounding singing voice that divides performance data into a transition part and a long sound part. The transition part is represented by articulation (phonemic chain) data that is read from an articulation template database and is outputted without modification. For the long sound part, a new characteristic parameter is generated by linearly interpolating characteristic parameters of the transition parts positioned before and after the long sound part and adding thereto a changing component of stationary data that is read from a constant part (stationary) template database. An associated apparatus for carrying out the singing voice synthesizing method includes a phoneme database for storing articulation data for the transition part and stationary data for the long sound part, a first device for outputting the articulation data, and a second device for outputting the newly-generated characteristic parameter of the long sound part.

U.S. Pat. No. 7,365,260 proposes that music piece sequence data are composed of a plurality of event data which include performance event data and user event data designed for linking a voice to progression of a music piece. A plurality of voice data files are stored in a memory separately from the music piece sequence data. In music piece reproduction, the individual event data of the music piece sequence data are sequentially read out, and a tone signal is generated in response to each readout of the performance event data. In the meantime, a voice reproduction instruction is outputted in response to each readout of the user event data. In accordance with the voice reproduction instruction, a voice data file is selected from among the voice data files stored in the memory, and a voice signal is generated on the basis of each read-out voice data.

U.S. Pat. No. 7,408,106 proposes a system and method of tele-karaoke that enables a user to perform and record karaoke using a terminal such as a cellular telephone. The karaoke performance is recorded as an MMS message which subsequently allows a user to send the recorded performance to others. The system is said to allow users to record their karaoke performance in less public forums and without any specialized equipment other than a cellular telephone or a personal computer. Since the karaoke performance is recorded as an MMS message, it can be edited to incorporate various media and sent to others at subsequent times.

U.S. Patent Publication No. 2005/0254631 proposes computer-generated personalized voice messages that are created by concatenating data files of audio that were pre-recorded in the voice of an individual whose live voice is to be simulated during the delivery of the voice message. A call to a person or list of persons is placed by a computer. Common identifiers of each person to be called are read from a data base of data files, and matched with a separate data base containing recorded voice phrases, each of which is a digitization of the individual speaking content corresponding to the identifier—such as the person's first name. The recorded voice phrase audio is concatenated with at least one other audio file, which is a digitization of a message to be delivered to the called person.

U.S. Patent Publication No. 2006/0028951 proposes a method for creating a customized audio track involving the steps of creating a song template, and then defining insert regions where sounds, vocals, or the like are inserted into the template. The method includes the steps of generating a list of inserts, and pre-recording or otherwise acquiring a recording of each insert. When a particular insert is selected, it is introduced into the insert region, and the customized audio track may be recorded, streamed, or otherwise used or delivered to a listener. The audio track may comprise a personalized song (using appropriate name inserts) or a cell phone ring tone that identifies the caller.

U.S. Patent Publication No. 2006/0123975A1 proposes personalizing or tailoring techniques for creative compositions. Methods and systems may create personalized or tailored audio and/or video compositions. Methods and systems may collect audio and/or visual tailoring requests from one individual or a plurality of individuals. The method and system may associate requests with: a sound or plurality of sounds, an image or plurality of images. The method and system may associate requests with at least one message. The method and system may combine the sounds, and/or the images with a message or plurality of messages and create at least one personalized or tailored composition. The method and system may distribute the personalized or tailored composition to at least one individual, through one or a plurality of communication methods. The method and system may store the personalized or tailored composition.

U.S. Patent Publication No. 2008/0091571 proposes systems and methods for customizing media (e.g., songs, text, books, stories, video, audio) via a computer network, such as the Internet. In particular, the systems and methods provide for construction of on-line social communities where orders for customized media or representative material associated with a performer's repertoire are received, performers associated with the on-line social communities are thereafter assigned to work on the orders for customized media based on their repertoire. On completion of the customization phase by the performers assigned to work on the orders and associated with the on-line social communities, the customized media is distributed to the users who initiated the order.

Despite these advances in the art, there is still a need for a system and method capable of altering the lyrics of a song to produce a custom song that gives the impression that the song was sung that way originally.

### SUMMARY

In one aspect, disclosed herein is an expert system based system for customizing a song for a system user. The system includes a song acquisition module having access to the internet or a network, or other song sources, a knowledge acquisition control consol, the knowledge acquisition control consol operatively connected to the song acquisition module, a characteristics extraction module the characteristics extraction module operatively connected to the song acquisition module, knowledge generation module, the knowledge generation module configured to communicate with the knowledge acquisition control consol, a knowledge base module, the knowledge base module configured to work with an inference engine module and communicate with the knowledge acquisition control consol, the inference engine module configured to use the knowledge base for reasoning and communicate with the song synthesizer; and an a graphics user interface to interface with system users, and a song synthesizer for generating a song according to the requirements of a system user and directions of the inference engine module.

In one form, the song acquisition module, knowledge acquisition control consol, characteristics extraction module, knowledge generation module, knowledge base module, and inference engine module are configured to generate a collection set of artificial intelligence singers (AIS), which possess all the knowledge and characteristics of a known singer or artist and collectively form an AIS generator (AISG).

In another form, the system includes a song delivery module operatively connected to the graphics user interface.

In yet another form, the graphics user interface and song delivery module cooperate to serve users as interfaces to request and obtain a customized song.

In still yet another form, the song synthesizer is configured so as to communicate with the AISG.

In a further form, the system includes a customization management module effective to manage song customization through communication with the AISG, song synthesizer, graphics user interface and delivery module.

In a yet further form, the knowledge acquisition control consol is configured for interfacing with a knowledge engineer.

In a still yet further form, the song acquisition module is configured to obtain a song either from a network, the internet or the knowledge engineer.

In another aspect, disclosed herein is a method of customizing a song for a user. The method includes the steps of selecting a particular song having lyrics sung by an singer, acquiring the song, analyzing the singer's voice and singing characteristics, including speech characteristics, words sung, tonal characteristics, including pitch, storing the voice characteristics of the singer in a knowledge base as knowledge generated by knowledge generation module, displaying the lyrics to the user, inputting a word substitution to customize the lyrics, simulating the artist's voice and substituting the words in the song to form a customized song and delivering the customized song file to a user.

These and other features will be apparent from the detailed description taken with reference to the accompanying drawing.

### BRIEF DESCRIPTION OF THE DRAWING

Further explanation may be achieved by reference to the description that follows and the drawing illustrating, by way of a non-limiting example, wherein:

The FIGURE depicts an expert system based system for customizing a song for a system user, in accordance herewith.

### DETAILED DESCRIPTION

Various aspects will now be described with reference to specific forms selected for purposes of illustration. It will be appreciated that the spirit and scope of the systems and methods disclosed herein are not limited to the selected forms. Moreover, it is to be noted that the figure provided herein is not drawn to any particular proportion or scale, and that many variations can be made to the illustrated forms. Reference is now made to the FIGURE.

Each of the following terms written in singular grammatical form: “a,” “an,” and “the,” as used herein, may also refer to, and encompass, a plurality of the stated entity or object, unless otherwise specifically defined or stated herein, or, unless the context clearly dictates otherwise.

Each of the following terms: “includes,” “including,” “has,” “‘having,” “comprises,” and “comprising,” and, their linguistic or grammatical variants, derivatives, and/or conjugates, as used herein, means “including, but not limited to.”

Throughout the illustrative description, the examples, and the appended claims, a numerical value of a parameter, feature, object, or dimension, may be stated or described in terms of a numerical range format. It is to be fully understood that the stated numerical range format is provided for illustrating implementation of the forms disclosed herein, and is not to be understood or construed as inflexibly limiting the scope of the forms disclosed herein.

Moreover, for stating or describing a numerical range, the phrase “in a range of between about a first numerical value and about a second numerical value,” is considered equivalent to, and means the same as, the phrase “in a range of from about a first numerical value to about a second numerical value,” and, thus, the two equivalently meaning phrases may be used interchangeably.

It is to be understood that the various forms disclosed herein are not limited in their application to the details of the order or sequence, and number, of steps or procedures, and sub-steps or sub-procedures, of operation or implementation of forms of the methods or to the details of type, arrangement, and order of steps set forth in the following illustrative description and examples, unless otherwise specifically stated herein. The systems and methods disclosed herein can be practiced or implemented according to various other alternative forms and in various other alternative ways.

It is also to be understood that all technical and scientific words, terms, and/or phrases, used herein throughout the present disclosure have either the identical or similar meaning as commonly understood by one of ordinary skill in the art, unless otherwise specifically defined or stated herein. Phraseology, terminology, and, notation, employed herein throughout the present disclosure are for the purpose of description and should not be regarded as limiting.

Disclosed herein is an expert system based system for customizing a song for a system user. The system includes a song acquisition module having access to the internet or a network, or other song sources, a knowledge acquisition control consol, the knowledge acquisition control consol operatively connected to the song acquisition module; a characteristics extraction module the characteristics extraction module operatively connected to the song acquisition module; knowledge generation module, the knowledge generation module configured to communicate with the knowledge acquisition control consol; a knowledge base module, the knowledge base module configured to work with the inference engine module and communicate with the knowledge acquisition control consol, the inference engine module configured to use the knowledge base for reasoning and communicate with the song synthesizer; and an a graphics user interface to interface with system users; and a song synthesizer for generating a song according to the requirements of a system user and directions of the inference engine module.

Also disclosed herein is a method of customizing a song for a user. The method includes the steps of selecting a particular song having lyrics sung by an singer, acquiring the song, analyzing the singer's voice and singing characteristics, including speech characteristics, words sung, tonal characteristics, including pitch, storing the voice characteristics of the singer in a knowledge base as knowledge generated by knowledge generation module, displaying the lyrics to the user, inputting a word substitution to customize the lyrics, simulating the artist's voice and substituting the words in the song to form a customized song and delivering the customized song file to a user.

As may be appreciated by those skilled in the art, an expert system attempts to provide an answer to a problem, or clarify uncertainties where normally one or more human experts would need to be consulted. Expert systems are most common in a specific problem domain and are a traditional application and/or subfield of artificial intelligence. A wide variety of methods can be used to simulate the performance of the expert, however, common to most are 1) the creation of a knowledge base which uses some knowledge representation formalism to capture the Subject Matter Expert's (SME) knowledge and 2) a process of gathering that knowledge from the SME and codifying it according to a formalism, which is called knowledge engineering. Expert systems may or may not have learning components but a third common element is that once the system is developed, it is proven by being placed in the same real world problem solving situation as the human SME, typically as an aid to human workers or a supplement to some information system.

Characteristics of expert systems and their architecture include the fact that the sequence of steps taken to reach a conclusion is dynamically synthesized with each new case. It is not explicitly programmed when the system is built. Expert systems can process multiple values for any problem parameter. This permits more than one line of reasoning to be pursued and the results of incomplete (not fully determined) reasoning to be presented. Problem solving is accomplished by applying specific knowledge rather than specific technique. This is a key idea in expert systems technology. It reflects the belief that human experts do not process their knowledge differently from others, but they do possess different knowledge. With this philosophy, when one finds that their expert system does not produce the desired results, work begins to expand the knowledge base, rather than to reprogram the procedures.

There are various expert systems in which a knowledge base or rulebase and an inference engine cooperate to simulate the reasoning process that a human expert pursues in analyzing a problem and arriving at a conclusion. In these systems, in order to simulate the human reasoning process, a vast amount of knowledge is required to be stored in the knowledge base. Generally, the knowledge base of such an expert system consisted of a relatively large number of “if then” type of statements that were interrelated in a manner that, in theory at least, resembled the sequence of mental steps that were involved in the human reasoning process.

The principal distinction between expert systems and traditional problem solving programs is the way in which the problem related expertise is coded. In traditional applications, problem expertise is encoded in both program and data structures. In the expert system approach all of the problem related expertise is encoded in data structures only; no problem-specific information is encoded in the program structure. This organization has several benefits.

The general architecture of an expert system involves two principal components: a problem dependent set of data declarations called the knowledge base or rule base, and a problem independent (although highly data structure dependent) program which is called the inference engine.

There are generally three individuals having an interaction with expert systems. Primary among these is the end-user; the individual who uses the system for its problem solving assistance. In the building and maintenance of the system there are two other roles: the problem domain expert who builds and supplies the knowledge base providing the domain expertise, and a knowledge engineer who assists the experts in determining the representation of their knowledge, enters this knowledge into an explanation module and who defines the inference technique required to obtain useful problem solving activity. Usually, the knowledge engineer will represent the problem solving activity in the form of rules which is referred to as a rule-based expert system. When these rules are created from the domain expertise, the knowledge base stores the rules of the expert system.

An understanding of the “inference rule” concept is important to understand expert systems. An inference rule is a statement that has two parts, an “if” clause and a “then” clause. This rule is what gives expert systems the ability to find solutions to diagnostic and prescriptive problems.

An expert system's rulebase is made up of many such inference rules. They are entered as separate rules and it is the inference engine that uses them together to draw conclusions. Because each rule is a unit, rules may be deleted or added without affecting other rules (though it should affect which conclusions are reached). One advantage of inference rules over traditional programming is that inference rules use reasoning which more closely resemble human reasoning. Thus, when a conclusion is drawn, it is possible to understand how this conclusion was reached. Furthermore, because the expert system uses knowledge in a form similar to the expert, it may be easier to retrieve this information from the expert.

A shell is a complete development environment for building and maintaining knowledge-based applications. It provides a step-by-step methodology, and ideally a user-friendly interface such as a graphical interface, for a knowledge engineer that allows the domain experts themselves to be directly involved in structuring and encoding the knowledge. Examples of shells include CLIPS and eGanges. CLIPS is a forward-chaining rule-based programming language written in C that also provides procedural and object-oriented programming facilities and is available at www.sourceforge.net. eGanges (electronic Glossed adversarial nested graphical expert system) is an expert system shell, mainly for the domains of law, quality control management, and education and is available at www.grayske.com.

With the above as background into expert system based systems, reference is now made to the FIGURE, which presents one form of a system for customizing a song 10. As shown, system 10 includes a song acquisition module 12, song acquisition module 12 having access to the internet whether directly or through a network connection. Song acquisition module 12 is operatively connected to knowledge acquisition control consol 14 and characteristics extraction module 16. Knowledge acquisition control consol 14 is also configured to communicate with knowledge generation module 18 and knowledge base module 20. Knowledge base module 20 and inference engine module 21 cooperate to form expert system 23. Inference engine 21 uses knowledge in knowledge base 20 to perform reasoning tasks.

The song acquisition module 12, knowledge acquisition control consol 14, characteristics extraction module 16, knowledge generation module 18 and expert system 23, including knowledge base module 20 and inference engine 21, are configured to generate a collection set of artificial intelligence singers (AIS), which possess all the knowledge and characteristics of a known singer or artist. Those components collectively called AIS generator (AISG) 22.

To interface with system users U, a graphics user interface 24 is provided, graphics user interface 24 operatively connected with delivery module 26. Combined, these two modules serve users as interfaces to request and obtain his/her customized song(s). Song synthesizer 28 generates a song according to the requirements set by user U and the directions from expert system 23 and is configured so as to communicate with AISG 22. Customization management module 30 manages the process of song customization through its communication with AISG 22, song synthesizer 28, graphics user interface 24 and delivery module 26.

As shown in the FIGURE, AISG 22 works independently of user U, in that user U has no control over AISG 22. AISG 22 establishes a set of artificial intelligence singers by working constantly or as long as it is asked to work by the system operator or knowledge engineer E. In operation, song acquisition module 12 obtains a song from network/internet I, or through the input of knowledge engineer E, with basic indexing information such as the name of the singer of the song, who wrote the content, who composed the music, etc. A song can also be provided by the knowledge engineer E through knowledge acquisition control console 14.

When a song is provided or acquired, the song will be sent to characteristics extraction module 16 for analysis and the characteristics of the singer's specific song extracted. The characteristics extraction module 16 extracts characteristics using an algorithm such as a conventional frequency spectrum analyzer utilizing wavelet transform methodology.

As those skilled in the art will recognize, the wavelet transform is a tool that transfers data or signals into different frequency components, and then studies each component with a resolution matched to its scale. Generally, wavelets are purposefully crafted to have specific properties that make them useful for signal processing. Wavelets can be combined, using a shift, multiply and sum technique called convolution, with portions of an unknown signal to extract information from the unknown signal.

For example, a wavelet could be created to have a frequency of Middle C and a short duration of roughly a 32nd note. If this wavelet were to be convolved at periodic intervals with a signal created from the recording of a song, then the results of these convolutions would be useful for determining when the Middle C note was being played in the song. Mathematically, the wavelet will resonate if the unknown signal contains information of similar frequency, just as a tuning fork physically resonates with sound waves of its specific tuning frequency.

Since wavelets are a mathematical tool, they can be used to extract information from many different kinds of data, including audio signals. Sets of wavelets are generally needed to analyze data fully. A set of complementary wavelets will deconstruct data without gaps or overlap so that the deconstruction process is mathematically reversible. Thus, sets of complementary wavelets are useful in wavelet based compression/decompression algorithms, where it is desirable to recover the original information with minimal loss.

More technically, a wavelet is a mathematical function used to divide a given function or continuous-time signal into different scale components. Usually one can assign a frequency range to each scale component. Each scale component can then be studied with a resolution that matches its scale. A wavelet transform is the representation of a function by wavelets. The wavelets are scaled and translated copies, known as daughter wavelets, of a finite-length or fast-decaying oscillating waveform, known as the mother wavelet. Wavelet transforms have advantages over traditional Fourier transforms for representing functions that have discontinuities and sharp peaks, and for accurately deconstructing and reconstructing finite, non-periodic and/or non-stationary signals.

Frequency spectrum analyzers utilizing wavelet transform for use in characteristics extraction module 16 are commercially available. Suitable analyzers include, but are not limited to the Wavelet Transform Spectrum Analyzer, available from www.sourceforge.net and MATLAB Wavelet Toolbox, available from The MathWorks, of Natick, Mass.

Those characteristics include the fundamental essentials of the song and are the essential components for synthesizing a song with different words, as though sung by the singer originally. In other words, the combination of the essential characteristics forms the song, just as light can be divided into three fundamental colors, red, blue, and yellow. A combination of differing amounts of the three fundamental colors forms a different beam of light having a different color. Those extracted characteristics will be sent to knowledge generation unit 18, so that they can be converted into a knowledge format and saved into knowledge base module 20. Knowledge base module 20 will index and categorize all the songs, their characteristics, and knowledge about a singer.

As may be appreciated, the knowledge base module grows as more songs are acquired through the above-mentioned process. However, the characteristics extracted from a specific song only represent, in most of cases, the characteristics of that particular song. Knowledge engineer E may be an expert having understanding of a particular singer. By using the knowledge acquisition control console 14, he/she will not only enhance the characteristics of a song, but also teach the system about features of a singer, such as the singer's technique of singing different types of songs, different feelings (e.g., sad, joyful), special singing effects, etc. Therefore, by continually refining the knowledge the artificial intelligence singer will more closely resemble an actual singer.

An artificial intelligence singer is refined through the following processes.
1) Growing the knowledge base within knowledge base module 20 through the acquisition of specific songs. This process includes the following steps:
   a. song acquisition by song acquisition module 12;
   b. characteristics extraction by characteristics extraction module 16;
   c. knowledge generation by knowledge generation module 18; and
   d. addition of that knowledge to the knowledge base of knowledge base module 20.
2) Refining a specific song's characteristics. This process includes the following steps:
   a. inputing/refining by knowledge engineer through knowledge acquisition control console 14;
   b. characteristics extraction by characteristics extraction module 16;
   c. knowledge generation by knowledge generation module 18; and
   d. addition of that knowledge to the knowledge base of knowledge base module 20.
3) Refining a singer's features: This process includes the following steps:
   a. inputing/refining by knowledge engineer through knowledge acquisition control console 14;
   b. knowledge generation by knowledge generation module 18;
   c. addition of that knowledge to the knowledge base of knowledge base module 20; and
   d. knowledge engineer commands song synthesizer 28 to generate songs by using the knowledge just stored in knowledge base 20 through the guidance of inference engine 21, compares the song generated by song synthesizer 28 with the original song whose features have been learned, tunes the features and updates the knowledge in knowledge base 20, and repeats the process until user satisfaction is reached.

Song customization is accomplished through the following process. First, a user U has selected a song that he/she wishes to change specific words to and have them replaced by the selected words, which are to sound as though they have been sung by the original singer or artist. The user U utilizes the graphics user interface 24, which may be operatively connected to a computer network and the internet to:
1) provide a song to the system or choose a song from the system;
2) if providing a song, then specify the name of the singer, corresponding contents of the song, and other logistics information;
3) specify the words of the song to be replaced; and
4) submit a customization request.

In the case where a user U requests a song and the song is not in knowledge base module 20, customization management module 30 obtains the song via song acquisition module 12 and sends the selected song to characteristics extraction module 16 to obtain fundamental characteristics. The characteristics extracted are saved into the knowledge base of knowledge base module 20 by following the above-described process. If a given song is in the knowledge base of knowledge base module 20, no extraction will be needed. Customization management module 30 will provide some high level requirements to inference engine module 21 and activate inference engine module 21. The inference engine module 21 will perform the reasoning based on the knowledge in knowledge base 20 to provide song synthesizer 28 with directions or instructions on how to mix the features, the amount of features to use, what are the characteristics to use, how to apply such as sequence, volume, etc. Still using color as an example, we may request for creating a color with high level requirements such as glossy and shiny. Inference engine 21 will perform the reasoning to decide the volume or intensity of three essential colors, red, green, and blue, plus the features of glossy and shiny for a color generator. Customization management module 30 will then direct song synthesizer module 28 to generate a song having the fundamental characteristics of the song selected with the user-selected words replaced. Delivery module 26 cooperates with the user U to deliver the song through email, or save as a file, or use other communication methods known by those skilled in the art.

For example, a user chooses a song having as part of its content “I love you.” A user can specify to replace the “you” in the song with “Hubin.” The customized song prepared in accordance with the system and methods described herein will sing “I love Hubin.” as if the original song was sung that way by the same selected singer or artist.

In another form, a music score is provided to create a song artificially sung by a singer selected by a user. As may be appreciated the system 10 will generate the song using a similar process.

As described herein, graphics user interface module 24, permitting a user to change the words of a song selected and customizing that sung according to his or her requirements. In order to accomplish this a text-to-speech engine is utilized within system 10. A wide variety of such engines are commercially available and adequate for these purposes. Other commercially available software may find utility in the practice of the system and methods described herein. By way of example, without intending to limit the present invention, software such as AV Voice Changer Software Diamond, distributed by Avnex, LTD of Nicosia, Cyprus may be utilized to change the tonal characteristics of the auditory representation of the singer or artist and the inflection or emotion of the recorded speech, such as by modifying the pitch, tempo, rate, equalization, and reverberation of the auditory representation.

In summary, the system disclosed herein operates to 1) analyze, from a singer's voice, song, and speech, the singer's voice and singing characteristics, including speech characteristics, words sung, tonal characteristics, including pitch (notes, etc.), 2) create a knowledge base that categorizes each singer's characteristics, set up rules for a variety of characteristics to make up different feelings (sad, joy, etc.), special singing effects, etc., 3) use above 1) and 2) to create any song with a music score of a song chosen by a user to generate a customized song sung by a singer selected from the system, and 4) to analyze a given song in order to obtain the song's specific characteristics, and to let a user provide content to replace at least a portion of the words in the song, then reconstruct the song just like the singer sang the user selected words in his/her original song.

The custom songs may be delivered to a user in a standard format such as WAV, MP3, or other conventional format, as one of ordinary skill in the art will recognize. The delivery of the recorded vocals can be through FTP, peer-to-peer networking, emailing of the content, or uploading to a website, for instance.

As may be appreciated, an exemplary environment for implementing various aspects of system and method disclosed herein includes a computer. The computer includes a processing unit, system memory, and a system bus. The system bus couples system components including, but not limited to, the system memory to the processing unit. The processing unit can be any of various available processors. Dual microprocessors and other multiprocessor architectures also can be employed as the processing unit. Multiple computers can of course be utilized in the system and method disclosed herein.

The system bus can be any of several types of bus structure(s) including the memory bus or memory controller, a peripheral bus or external bus, and/or a local bus using any variety of available bus architectures including, but not limited to, 15-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory includes volatile memory and nonvolatile memory. The basic input/output system (BIOS), containing the basic routines to transfer information between elements within the computer, such as during start-up, is stored in nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computers useful in the practice of the methods and systems disclosed herein also include removable/nonremovable, volatile/nonvolatile computer storage media, for example a disk storage. Disk storage includes, but is not limited to, devices like a magnetic disk drive, floppy disk drive, tape drive, Jaz drive, Zip drive, LS-100 drive, flash memory card, or memory stick. In addition, disk storage can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices to the system bus, a removable or non-removable interface is typically used such as interface.

It is to be appreciated that software is contemplated to act as an intermediary between users and the basic computer resources described herein. Such software includes an operating system. Such an operating system can be stored on disk storage and acts to control and allocate resources of the computer system. System applications take advantage of the management of resources by operating system through program modules and program data stored either in system memory or on disk storage. It is to be appreciated that the present invention can be implemented with various operating systems or combinations of operating systems.

A user enters commands or information into the computer through input device(s). Input devices include, but are not limited to, a poihting device such as a mouse, trackball, stylus, touch pad, keyboard, microphone, joystick, game pad, satellite dish, scanner, TV tuner card, digital camera, digital video camera, web camera, and the like. These and other input devices connect to the processing unit through the system bus via interface port(s). Interface port(s) include, for example, a serial port, a parallel port, a game port, and a universal serial bus (USB). Output device(s) use some of the same type of ports as input device(s). Thus, for example, a USB port may be used to provide input to the computer and to output information from the computer to an output device. An output adapter may be provided output devices like monitors, speakers, and printers among other output devices that require special adapters. The output adapters include, by way of illustration and not limitation, video and sound cards that provide a means of connection between the output device and the system bus. It should be noted that other devices and/or systems of devices provide both input and output capabilities such as remote computer(s).

The system computer(s) can operate in a networked environment using logical connections to one or more remote computers, such as remote computer(s). The remote computer(s) can be a personal computer, a server, a router, a network PC, a workstation, a microprocessor based appliance, a peer device or other common network node and the like, and typically includes many or all of the elements described relative to the computer(s). Remote computer(s) may be logically connected to the system computer(s) through a network interface and then physically connected via communication connection. The network interface encompasses communication networks such as local-area networks (LAN) and wide-area networks (WAN). LAN technologies include Fiber Distributed Data Interface (FDDI), Copper Distributed Data Interface (CDDI), Ethernet/IEEE, Token Ring/IEEE and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) include the hardware/software employed to connect the network interface to the bus. The hardware/software necessary for connection to the network interface includes, for exemplary purposes only, internal and external technologies such as, modems including regular telephone grade modems, cable modems and DSL modems, ISDN adapters, and Ethernet cards.

It is to be appreciated that the functionality of the present invention can be implemented using JAVA, XML or any other suitable programming language. The present invention can be implemented using any similar suitable language that may evolve from or be modeled on currently existing programming languages. Furthermore, the system and method disclosed herein can be implemented as a stand-alone application, as web page-embedded applet, or by any other suitable means.

Additionally, one skilled in the art will appreciate that this invention may be practiced on computer networks alone or in conjunction with other means for submitting information for customization of lyrics including but not limited to kiosks, facsimile or mail submissions and voice telephone networks. Furthermore, the invention may be practiced by providing all of the above-described functionality on a single stand-alone computer, rather than as part of a computer network.

The system disclosed herein may include one or more client(s). The client(s) can be hardware and/or software (e.g., threads, processes, computing devices). The system may also include one or more server(s). The server(s) can also be hardware and/or software (e.g., threads, processes, computing devices). One possible communication between a client and a server may be in the form of a data packet adapted to be transmitted between two or more computer processes. The system may include a communication framework that can be employed to facilitate communications between the client(s) and the server(s). The client(s) may be operably connected to one or more client data store(s) that can be employed to store information local to the client(s). Similarly, the server(s) may be operably connected to one or more server data store(s) that can be employed to store information local to the servers.

All patents, test procedures, and other documents cited herein, including priority documents, are fully incorporated by reference to the extent such disclosure is not inconsistent with this disclosure and for all jurisdictions in which such incorporation is permitted.

While the illustrative embodiments disclosed herein have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside herein, including all features which would be treated as equivalents thereof by those skilled in the art to which the disclosure pertains.

What is claimed is:

1. A method of customizing a song for a user, comprising the steps of:
(a) selecting a particular song having lyrics sung by an singer;
(b) acquiring the song;
(c) analyzing the singer's voice and singing characteristics, including speech characteristics, words sung, tonal characteristics, including pitch;
(d) storing the voice characteristics of the singer in a knowledge base;
(e) displaying the lyrics to the user;
(f) inputting a word substitution to customize the lyrics
(g) simulating the artist's voice and substituting the words in the song to form a customized song; and
(h) delivering the customized song file to a user.

2. The method of claim 1, wherein said delivering step is accomplished via a website.

3. The method of claim 1, wherein said song acquisition step is accomplished by a song acquisition module having access to the internet.

4. The method of claim 1, wherein said song acquisition step is accomplished by a knowledge engineer interfacing through a knowledge acquisition control consol.

5. The method of claim 1, wherein said step of analyzing the singer's voice and singing characteristics is accomplished by a characteristics extraction module and a knowledge generation module.

6. The method of claim 1, wherein said step of simulating the artist's voice and substituting the words in the song to form a customized song is accomplished by an inference engine module and a song synthesizer module.

7. The method of claim 6, further including the steps of commanding via a knowledge engineer, the song synthesizer module to generate a song by using knowledge stored in a knowledge base through the guidance of the inference engine, comparing the song generated by the song synthesizer with the original song, which features are learned, tuning the features and updating the knowledge in the knowledge base and repeating the process until the user is satisfied.

8. The method of claim 1, further comprising the step of interfacing with a graphics user interface and a song delivery module to request and obtain a customized song.

9. The method of claim 1, further comprising the step of employing a customization management module to manage song customization.

10. The method of claim 1, wherein said step of acquiring a song is accomplished by obtaining the song either from a network, the internet, a media source or a knowledge engineer.

11. The method of claim 10, wherein said step of acquiring a song further comprises obtaining basic indexing information including name of the song's singer, the song's composer.

12. An expert system based system for customizing a song for a system user, comprising:
(a) a song acquisition module having access to the internet,
(b) a knowledge acquisition control consol, said knowledge acquisition control consol operatively connected to said song acquisition module;
(c) a characteristics extraction module said characteristics extraction module operatively connected to said song acquisition module;
(d) knowledge generation module, said knowledge generation module configured to communicate with said knowledge acquisition control consol;
(e) a knowledge base module, said knowledge base module configured to communicate with said knowledge acquisition control consol; and an a graphics user interface to interface with system users;
(f) an inference engine module, said inference engine module configured to use said knowledge base module for reasoning; and
(g) a song synthesizer for generating a song according to the requirements of a system user, said song synthesizer configured to communicate with said inference engine module.

13. The system of claim 12, wherein said song acquisition module, said knowledge acquisition control consol, said characteristics extraction module, said knowledge generation module and said knowledge base module are configured to generate a collection set of artificial intelligence singers (AIS), which possess all the knowledge and characteristics of a known singer or artist and collectively form an AIS generator (AISG).

14. The system of claim 13, further comprising a song delivery module operatively connected to said graphics user interface.

15. The system of claim 14, wherein said graphics user interface and said song delivery module cooperate to serve users as interfaces to request and obtain a customized song.

16. The system of claim 15, wherein said song synthesizer is configured so as to communicate with said AISG.

17. The system of claim 16, further comprising a customization management module, said customization management module effective to manage song customization through communication with said AISG, said song synthesizer, said graphics user interface and said delivery module.

18. The system of claim 12, wherein said knowledge acquisition control consol is configured for interfacing with a knowledge engineer.

19. The system of claim 18, wherein said song acquisition module is configured to obtain a song either from a network, a media source, the internet or the knowledge engineer.

20. The system of claim 18, wherein said song acquisition module also obtains basic indexing information including name of the song's singer, the song's composer.

21. The system of claim 20, wherein said characteristics extraction module analyses the characteristics of a singer and the specific song extracted.
